(19) United States
(12) Patent Application Publication
(10) Pub. No.: US 2021/0057911 A1
(43) Pub. Date: Feb. 25, 2021

(54) ARRANGEMENT FOR REGULATING A POWER FLOW IN AN AC VOLTAGE GRID AND METHOD FOR PROTECTING THE ARRANGEMENT

(71) Applicant: SIEMENS AKTIENGESELLSCHAFT, Muenchen (DE)

(72) Inventor: MARTIN PIESCHEL, ALTDORF (DE)

(21) Appl. No.: 16/999,804

(22) Filed: Aug. 21, 2020

(30) Foreign Application Priority Data
Aug. 23, 2019 (EP) 19193436

(51) Int. Cl. H02J 3/18; H02J 3/46; H02M 7/48

(52) U.S. Cl. CPC H02J 3/1814; H02M 7/4826; H02J 3/46

(57) ABSTRACT

An arrangement for controlling a power flow in an AC voltage grid includes a converter arrangement having a first converter and a second converter. The converters are connectable to one another on the DC voltage side through a DC voltage link and are each connectable to the AC voltage grid on the AC voltage side. During the operation of the arrangement, the converters are correspondingly connected to the AC voltage grid. A switching branch is provided in the DC voltage link in parallel with the converters and at least one controllable switching element is provided in the switching branch. A method for protecting the arrangement in the case of an overload is also provided.

### CROSS-REFERENCE TO RELATED APPLICATION

This application claims the priority, under 35 U.S.C. § 119, of European Patent Application EP 19193436, filed Aug. 23, 2019; the prior application is herewith incorporated by reference in its entirety.

### BACKGROUND OF THE INVENTION

### Field of the Invention

The invention relates to an arrangement for controlling a power flow in an AC voltage grid including a converter arrangement having a first converter and a second converter, wherein the converters are connectable to one another on the DC voltage side through a DC voltage link and are each connectable to the AC voltage grid on the AC voltage side. During the operation of the arrangement, the converters are correspondingly connected to the AC voltage grid.

Such an arrangement can be used in particular for power flow control in electrical three-phase grids or supply networks. It is often referred to as a Universal Power Flow Controller (UPFC). One UPFC is known for example from the paper “Comprehensive Power Flow Analyses and Novel Feedforward Coordination Control Strategy for MMC-based UPFC” by Liu et al., in Energies 2019. The first converter of the known arrangement is usually referred to as a parallel converter, and the second converter as a series converter.

If grid short circuits occur in the AC voltage grid, then a grid short-circuit current develops which significantly exceeds the current-carrying capacity of the series converter. In order to avoid damage, in the case of the known arrangement, a short-circuiting unit composed of power semiconductors capable of being turned on, for example antiparallel-connected thyristors, is connected between the series converter and the AC voltage grid. In order to trigger the short-circuiting unit of the known arrangement, the series converter must first build up a required initial voltage. Depending on the construction of the series converter, an uncontrolled build-up of voltage at or in the series converter can occur in that case, which can result in damage to the series converter.

### BRIEF SUMMARY OF THE INVENTION

It is accordingly an object of the invention to provide an arrangement for regulating a power flow in an AC voltage grid and a method for protecting the arrangement, which overcome the hereinafore-mentioned disadvantages of the heretofore-known devices and methods of this general type and which are as cost-effective and reliable as possible during operation.

With the foregoing and other objects in view there is provided, in accordance with the invention, an arrangement for controlling a power flow in an AC voltage grid, comprising a converter arrangement having a first converter and a second converter, the converters being connectable to one another on the DC voltage side through a DC voltage link and each converter being connectable to the AC voltage grid on the AC voltage side, a switching branch provided in the DC voltage link in parallel with the converters, and at least one controllable switching element provided in the switching branch.

The switching branch connects the two DC voltage poles of the DC voltage link, in such a way that the voltage link can discharge through the at least one switching element in the case of a fault. One advantage of the arrangement according to the invention is that the switching branch can replace the short-circuiting unit described above. Upon the occurrence of an overcurrent, or as soon as such an overcurrent is identified in the arrangement, the at least one switching element can be triggered. A DC voltage is always present in the voltage link, so that the switching element can be triggered reliably at any time. Furthermore, a cost advantage results from the fact that the number of switching elements (for example thyristors) in the switching branch can be reduced by comparison with the short-circuiting unit described above, depending on the application. Moreover, a particularly compact embodiment is conceivable in this case. The structure of the second converter is suitably chosen in such a way that its rated current corresponds to the rated current of the AC voltage grid.

The at least one switching element is suitably configured for switching currents above 1 kA, preferably above 5 kA, within less than 10 ms, preferably less than 5 ms. The structure of the switching element for high currents is advantageous because, as shown by the Applicant's own investigations, the short-circuit current can rise to ten times the rated current. According to the Applicant's own investigations, these high currents have to be switched appropriately rapidly in order to be able to avoid damage to the arrangement or the overdesign thereof. The switching element(s) suitably has/have a forward direction corresponding to the current direction of the short-circuit current in the switching branch.

The at least one switching element can for example be a semiconductor switch, in particular a power semiconductor switch. One switching element that is simple in terms of construction and control and can satisfy the requirements is a thyristor, for example. Further examples are IGBTs, IGCTs or the like configured appropriately for the required current-carrying capacity. These have the advantage, in particular, that they are not only able to be turned on, but also able to be turned off.

Expediently, a multiplicity of switching elements, preferably of identical type, connected to one another in a series circuit, are provided in the switching branch. The number of switching elements is able to be chosen as desired, in principle, and can be adapted to the respective application. The switching elements are controllable, in that their control terminals are suitably connected to a common control device that can communicate corresponding drive signals to the switching elements. The blocking capability in the switching branch can advantageously be increased by the use of a plurality of switching elements.

In accordance with one embodiment of the invention, at least one of the converters is a modular multilevel converter (MMC). The modular multilevel converter is distinguished by a modular construction, in particular. The MMC includes converter arms extending in each case between a terminal of the MMC on the AC voltage side and one of the DC voltage poles of the voltage link. Each converter arm includes a series circuit formed by switching modules. Each switching module includes a plurality of semiconductor switches, which are preferably capable of being turned off, and also an energy storage unit, usually in the form of a module capacitor. By suitable driving of the semiconductor switches of the switching modules, at least a voltage corresponding to the energy storage voltage or a zero voltage can be generated at the terminals of each of the switching modules. It is considered to be advantageous if both the first converter and the second converter are MMCs. Other voltage source converters (VSC) are conceivable as an alternative to the MMC. The MMC has the advantage, in particular, that due to the virtually ideal sinusoidal voltage generated, it is possible to largely dispense with filters on the DC voltage side and on the AC voltage side.

Since the voltage that can be generated at each converter arm is dimensioned according to the number of switching modules connected in series there, the voltage that can be generated overall at the respective MMC can be determined by the number of switching modules overall. It is considered to be advantageous if the number of switching modules, overall or in each converter arm, is dimensioned in such a way that the voltage that can be generated by the MMC is at least 5% greater than a predetermined rated voltage. What can be achieved in this way is that even in the event of failure of a corresponding number of switching modules, the required rated voltage can still be provided by the converter.

Preferably, the switching modules of the MMC are half-bridge switching modules or full-bridge switching modules. Each of the semiconductor switches in the switching module is suitably assigned a freewheeling diode connected in antiparallel therewith. Half-bridge switching modules have the advantage of relatively low losses during operation. For example, the second converter can be an MMC having half-bridge switching modules. In such a case, upon the occurrence of a fault, the short-circuit current can flow through the freewheeling diodes and the switching branch. The full-bridge switching module is constructed in such a way that in addition to the energy storage voltage and the zero voltage, an energy storage voltage having opposite polarity can also be generated at the terminals of the switching module. An MMC having full-bridge switching modules can thus build up a back EMF. It is considered to be advantageous if the first converter is an MMC having full-bridge switching modules. The latter is configured to generate a back EMF on its DC voltage side. The back EMF can be used to reduce the current through the switching branch to zero at least for a short time. In this way, for example, thyristors used as switching elements can be turned off. In order to charge (recharge) the energy storage units of the switching modules of the second converter, it is possible to generate a positive link voltage in the voltage link by the first converter. It should be noted here that other circuit topologies of the switching modules of the two converters are also conceivable, of course.

In accordance with one embodiment of the invention, each switching module is assigned a protective circuit-breaker, preferably a protective thyristor, through the use of which a current through the switching element is able to be limited. The protective circuit-breaker is preferably disposed in parallel with the connecting terminals of the switching module. In the case of a fault, the protective circuit-breaker can be used to carry the short-circuit current. By way of example, a separate high-power diode can also be used instead of a protective thyristor.

Preferably, the first converter is connected to the AC voltage grid by a matching transformer. In this context, the matching transformer is often referred to as a parallel transformer or shunt transformer. The matching transformer is expediently configured in such a way that, through the use of the matching transformer, a zero system current in the case of a fault cannot flow into the first converter. It may be advantageous if the turns of the matching transformer on the AC voltage side are connected to one another in a delta connection, while the turns of the matching transformer on the converter side are connected to one another in a star connection. The matching transformer preferably has an on-load voltage matching, e.g. a tap switch.

Preferably, the second converter is connected to the AC voltage grid by a serial transformer. In this case, a turn of the serial transformer on the AC voltage side is inserted in series into an AC voltage line of the AC voltage grid. The serial transformer (series transformer) has the task, in particular, of establishing a galvanic isolation between the AC voltage grid and the second converter. The turns of the series transformer on the converter side can be connected to one another for example in a delta or a star point connection.

Particularly preferably, a connection of the first or of the second converter to the AC voltage grid is able to be bridged by a bridging switch. In particular, the connection can be bridgeable by the serial transformer. In this case, the bridging switch suitably bridges the current flow through the turns of the serial transformer on the AC voltage side. The switching branch need only carry the short-circuit current until the bridging switch is opened. The bridging switch can be a mechanical switch, for example.

As mentioned above, it is an object of the invention to provide a method for protecting an arrangement for regulating a power flow in an AC voltage grid that is as reliable as possible.

With the objects of the invention in view, there is concomitantly provided a method for protecting an arrangement for regulating a power flow in an AC voltage grid, which comprises the following method steps: identifying an overload fault in the AC voltage grid and/or the arrangement, switching the at least one switching element in the switching branch of the arrangement, thereby enabling a current flow through the switching branch, and bridging a connection of the first and/or of the second converter to the AC voltage grid by a bridging switch provided for this purpose.

The fault identification can be effected for example on the basis of an evaluation of a current through the arrangement or a corresponding rise in current. A criterion in this case can be, for example, an exceedance of a threshold of double, preferably five times, a rated current. For this purpose, the arrangement can have suitable measuring devices such as e.g. current converters and/or voltage converters. If more than one switching element is switched in the switching branch, then the switching elements are preferably turned on simultaneously (the drive signal is transmitted simultaneously, under certain circumstances taking account of the corresponding line lengths). The switching elements preferably reach the on state within 5 ms. The switching element(s) remain(s) turned on at least until the bridging switch accepts the current. As already mentioned above, the bridging switch can be a mechanical switch.

A major advantage of the method according to the invention is that reliable protection of the arrangement is provided, wherein at the same time complex switching configurations, such as a known double thyristor shunt, for example, can be dispensed with. Further advantages are evident from the advantages described above in association with the arrangement according to the invention.

Other features which are considered as characteristic for the invention are set forth in the appended claims.

Although the invention is illustrated and described herein as embodied in an arrangement for regulating a power flow in an AC voltage grid and a method for protecting the arrangement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic and block diagram showing one exemplary embodiment of an arrangement according to the invention;

FIG. 2 is a schematic and block diagram showing one example of an MMC for the arrangement of FIG. 1;

FIG. 3 is a schematic diagram showing a first example of a switching module for the MMC of FIG. 2; and

FIG. 4 is a schematic diagram showing a second example of a switching module for the MMC of FIG. 2.

### DETAILED DESCRIPTION OF THE INVENTION

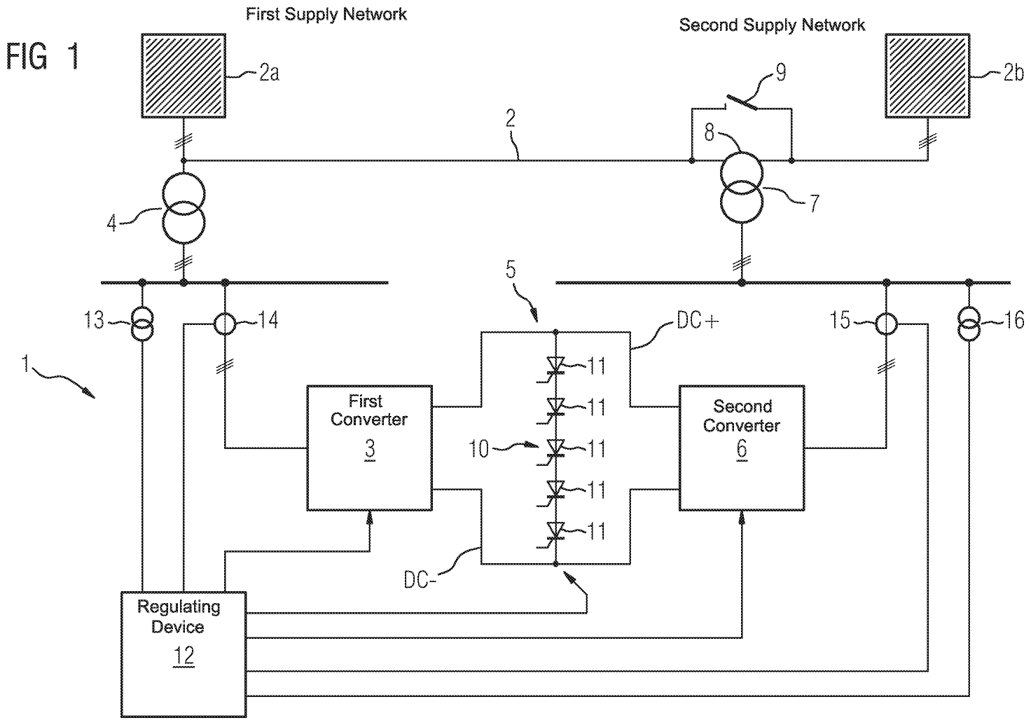

Referring now to the figures of the drawings in detail and first, particularly, to FIG. 1 thereof, there is seen an arrangement 1 for controlling a power flow in an AC voltage grid. In the example shown in FIG. 1, an AC voltage grid 2 is represented by a transmission line between a first supply network 2a and a second supply network 2b. The arrangement 1 includes a first converter 3. The first converter 3 is connected to the AC voltage grid 2 on the AC voltage side by a parallel transformer 4. Furthermore, the first converter 3 is connected to a second converter 6 on the DC voltage side through a voltage link 5. The second converter 6 is connected to the AC voltage grid 2 on the AC voltage side by a series transformer 7. The connection of the second converter 6 to the AC voltage grid 2, in the example shown, in particular, the windings 8 of the series transformer 7 on the AC voltage side, can be bridged by a mechanical bridging switch 9.

A switching branch 10 extending between a first and a second DC voltage pole DC+, DC− is disposed in the voltage link 5. A series circuit formed by switching elements in the form of thyristors 11 is disposed in the switching branch 10.

The arrangement 1 furthermore includes a regulating device or drive unit 12 configured for driving semiconductor switches of the converters 3, 6 and the thyristors 11. The regulating device 12 is connected to a current measuring device 14 for measuring a current through the first converter 3, to a voltage measuring device 13 for measuring terminal voltages of the first converter 3, to a further current measuring device 15 for measuring a current through the second converter 6, and to a further voltage measuring device 16 for measuring terminal voltages of the second converter 6.

The regulating device 12 is configured to detect a fault situation, for example an overload situation, on the basis of the current and voltage monitoring. To that end, a check is made, for example, to ascertain whether the measured current exceeds a predetermined current threshold. If such an overload fault is identified, then the switching units 11 in the switching branch are turned on by using corresponding driving signals, thereby enabling a current flow, in particular a short-circuit current, through the switching branch. At the same time or afterward, the bridging switch 9 is driven to turn on. Through the use of the bridging switch, the series transformer 7 and thus the connection of the second converter 6 to the AC voltage grid 2 are bridged, in such a way that the arrangement 1 overall is protected against overload.

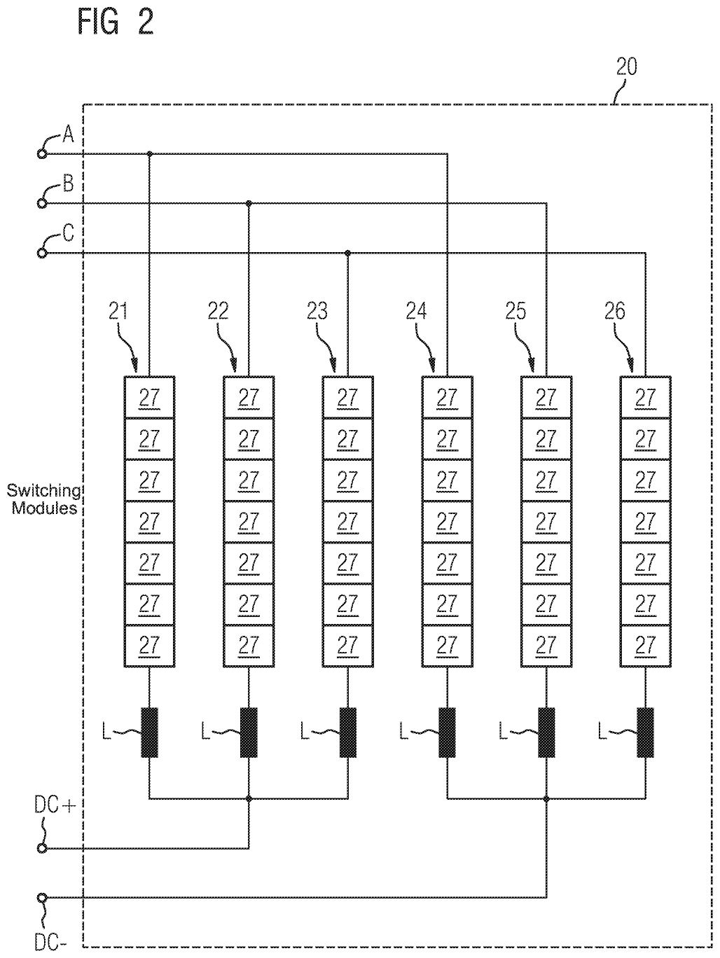

FIG. 2 illustrates an MMC 20, which is useable as a first and/or a second converter 3, 6 of the arrangement 1 of FIG. 1. The MMC 20 is embodied in three-phase fashion and accordingly includes three AC voltage terminals A, B, C and also a first DC voltage terminal for connection to the first DC voltage pole DC+ and a second DC voltage terminal for connection to the second DC voltage pole DC−. The MMC 20 includes six converter arms 21-26 extending in each case between one of the AC voltage terminals A-C and one of the DC voltage terminals. Each converter arm 21-26 has an arm inductance L and a series circuit formed by switching modules 27.

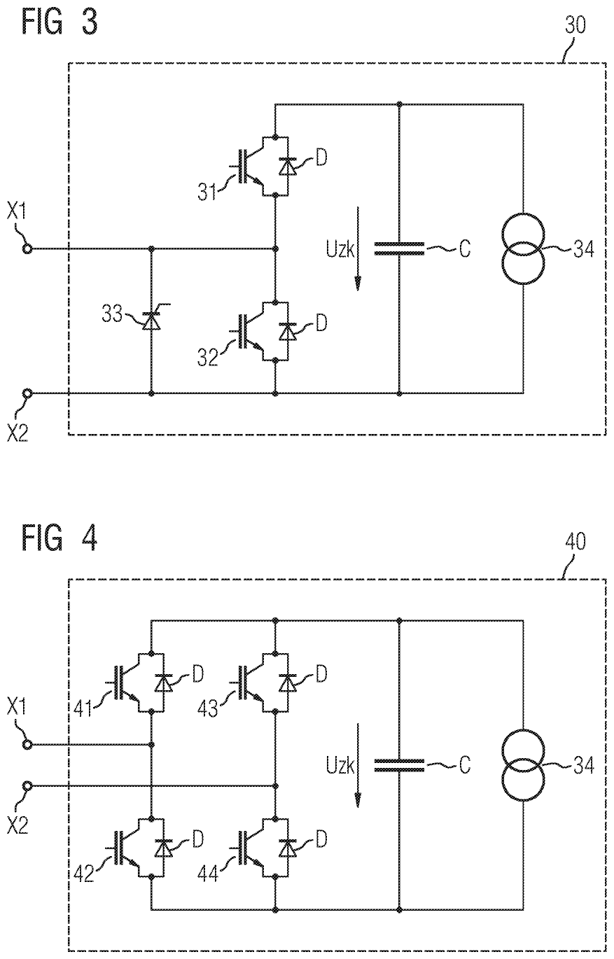

FIG. 3 illustrates a half-bridge switching module 30, which is useable as a switching module 27 in the MMC 20 of FIG. 2. The half-bridge switching module 30 includes a first semiconductor switch 31 and a second semiconductor switch 32, with a respective freewheeling diode D being connected antiparallel with each of the semiconductor switches. A capacitor C is disposed between a collector terminal of the first semiconductor switch 31 and an emitter terminal of the second semiconductor switch 32. A protective thyristor 33 is disposed between a first terminal X1 and a second terminal X2 of the half-bridge switching module 30 and can carry the short-circuit current in accordance with its forward direction in the case of a fault in order to relieve the load on the semiconductor switches 31, 32. A voltage meter 34 serves for monitoring a capacitor voltage Uzk across the capacitor C.

FIG. 4 illustrates a full-bridge switching module 40, which is useable as a switching module 27 in the MMC 20 of FIG. 2. The full-bridge switching module 40 includes a first semiconductor switch 41 and a second semiconductor switch 42, a third semiconductor switch 43 and a fourth semiconductor switch 44, with a respective freewheeling diode D being connected antiparallel with each of the semiconductor switches. A capacitor C is disposed between collector terminals of the first semiconductor switch 41 and the third semiconductor switch 43 and emitter terminals of the second semiconductor switch 42 and the fourth semiconductor switch 44. A first terminal X1 of the full-bridge switching module 40 is disposed between the first and second semiconductor switches 41, 42, and a second terminal X2 of the full-bridge switching module 40 is disposed between the third and fourth semiconductor switches 43, 44.

1. An arrangement for controlling a power flow in an AC voltage grid, the arrangement comprising:
a DC voltage link; and
a converter arrangement including a first converter and a second converter, said converters configured to be connected to one another on a DC voltage side through said DC voltage link and said converters each configured to be connected on an AC voltage side to the AC voltage grid;
said DC voltage link containing a switching branch connected in parallel with said converters, said switching branch containing at least one controllable switching element.

2. The arrangement according to claim 1, wherein said at least one controllable switching element is configured for switching currents above 1 kA within less than 20 ms.

3. The arrangement according to claim 1, wherein said at least one controllable switching element is configured for switching currents above 1 kA within less than 10 ms.

4. The arrangement according to claim 1, wherein said at least one controllable switching element is a semiconductor switch.

5. The arrangement according to claim 3, wherein said semiconductor switch is a thyristor.

6. The arrangement according to claim 1, wherein said at least one controllable switching element includes a multiplicity of controllable switching elements connected to one another in a series circuit in said switching branch.

7. The arrangement according to claim 1, wherein at least one of said converters is a modular multilevel converter.

8. The arrangement according to claim 7, wherein said modular multilevel converter includes a number of series-connected switching modules, said number being dimensioned to cause said modular multilevel converter to generate a voltage being at least 5% greater than a predetermined rated voltage.

9. The arrangement according to claim 8, wherein said switching modules are half-bridge switching modules or full-bridge switching modules.

10. The arrangement according to claim 8, which further comprises protective circuit-breakers each being assigned to a respective one of said switching modules for limiting a current through said at least one controllable switching element.

11. The arrangement according to claim 1, which further comprises a matching transformer connecting said first converter to the AC voltage grid.

12. The arrangement according to claim 1, which further comprises a serial transformer connecting said second converter to the AC voltage grid.

13. The arrangement according to claim 1, which further comprises a bridging switch configured to bridge a connection of said first or second converter to the AC voltage grid.

14. A method for protecting an arrangement for controlling a power flow in an AC voltage grid, the method comprising:
providing the arrangement according to claim 1;
identifying an overload fault in at least one of the AC voltage grid or the arrangement;
switching said at least one controllable switching element in said switching branch of the arrangement to enable a current flow through said switching branch; and
using a bridging switch to bridge a connection of said first or second converter to the AC voltage grid.
